(19) United States
(12) Patent Application Publication
(10) Pub. No.: US 2025/0062605 A1
(43) Pub. Date: Feb. 20, 2025

(54) HOT-PLUG PROTECTION METHOD AND POWER SUPPLY DEVICE

(71) Applicant: Delta Electronics (Shanghai) Co.,Ltd., Shanghai (CN)

(72) Inventors: Yuxin ZHANG, Shanghai (CN); Kehua MA, Shanghai (CN); Daofei XU, Shanghai (CN); Haitao ZHANG, Shanghai (CN); Bingtao HU, Shanghai (CN)

(21) Appl. No.: 18/806,272

(22) Filed: Aug. 15, 2024

(30) Foreign Application Priority Data
Aug. 16, 2023 (CN) 202311037076.7

(51) Int. Cl. H02H 3/12; H02H 1/00

(52) U.S. Cl. CPC H02H 3/12; H02H 1/0007

(57) ABSTRACT

The present disclosure relates to a hot-plug protection method and a power supply device. The method includes, when the connection status between the power supply device and the to-be-charged device is detected as disconnected through the detection pin, turning off a switch assembly within a first time period, where the switch assembly is connected in series between the voltage converter of the power supply device and the connection port, and maintaining an output voltage of the voltage converter at a first level within a second time period, the first time period being shorter than the second time period.

### CROSS-REFERENCE TO RELATED APPLICATIONS

The present application claims priority to Chinese patent application No. 202311037076.7, filed on Aug. 16, 2023, the entire content of which is incorporated herein by reference.

### TECHNICAL FIELD

The present disclosure relates to the field of electronic circuit technology, particularly to a hot-plug protection method and power supply device.

### BACKGROUND

Hot plug refers to connecting or disconnecting a device while it is still powered on. During a hot plug operation, if the output voltage cannot quickly drop to a safe voltage range, it can easily result in interface damage or device malfunction.

With the increasing functionality of consumer electronics, the power requirements have also become higher. Some high-power consumer electronic products require 20V or even 48V. When charging, if users connect the consumer electronic product in a hot-plug manner while the power supply is still powered on, a significant voltage difference may occur between two contact points of connectors, leading to sparking and thus causing oxidation or aging of the connector's contact points, which subsequently affects the lifespan of the connectors.

### SUMMARY

One aspect of the present disclosure provides a hot-plug protection method for a power supply device. The power supply device includes a connection port through which the power supply device provides charging power to a to-be-charged device, a voltage converter and a switch assembly connected in series between the voltage converter and the connection port. The connection port includes a detection pin that detects the connection status between the power supply device and the to-be-charged device. The method includes, when the connection status between the power supply device and the to-be-charged device is detected as disconnected through the detection pin, turning off the switch assembly within a first time period, and maintaining an output voltage of the voltage converter at a first level within a second time period. The first time period is shorter than the second time period.

In some embodiments, the first time period is determined based on a delay time from the connection status becoming disconnection to a disconnection of an input terminal of the to-be-charged device, and the first time period is set between zero and the delay time.

In some embodiments, the first time period is less than 20 ms, and the second time period is set between the first time period and 275 ms.

In some embodiments, a voltage difference between the first level and a reference level is between-50% and +20%. The reference level is equal to the output voltage of the voltage converter when the power supply device provides charging power to the to-be-charged device.

In some embodiments, the method further includes, when the connection status between the power supply device and the to-be-charged device is detected as disconnected through the detection pin, after the second time period and within a third time period, reducing the output voltage of the voltage converter from the first level to a second level, the second level being equal to the output voltage of the voltage converter when the power supply device is in an unloaded state.

In some embodiments, the third time period is set between the second time period and 275 ms.

In some embodiments, the connection status between the power supply device and the to-be-charged device being detected as disconnected through the detection pin includes detecting a voltage value on the detection pin, and when the voltage value on the detection pin is greater than or equal to a first predetermined voltage, determining that the to-be-charged device and the power supply device are disconnected.

In some embodiments, the method includes, when the connection status between the power supply device and the to-be-charged device is detected as connected through the detection pin and a first predetermined condition is met, turning on the switch assembly to allow communication with the to-be-charged device.

In some embodiments, within the second time period, the voltage difference between the power supply device and the to-be-charged device is less than or equal to 5V.

In some embodiments, the connection status between the power supply device and the to-be-charged device being detected as connected through the detection pin includes detecting a voltage value on the detection pin, and when the voltage value on the detection pin is less than or equal to a second predetermined voltage, determining that the to-be-charged device is connected to the power supply device.

In some embodiments, whether the first predetermined condition is met is determined by detecting a voltage value of a power terminal of the connection port and the output voltage of the voltage converter, and when the voltage value of the power supply terminal is less than or equal to a third predetermined voltage and the output voltage of the voltage converter is equal to the second level, it is determined that the first predetermined condition is met.

In some embodiments, the connection port includes multiple pins including the detection pin, and a length of the detection pin is shorter than those of remaining pins, with a difference ranging from 0.3 to 0.5 mm.

Another aspect of the present disclosure provides a power supply device. The power supply device includes a connection port, a controller configured to perform a hot-plug protection method according to any one of the described embodiments, to protect the power supply device, a voltage converter configured to output corresponding voltages according to instructions from the controller, and a switch assembly connected in series between the voltage converter and the connection port and configured to turn on or turn off a power output of the power supply device according to control signals from the controller.

In some embodiments, the switch assembly includes a MOSFET with a body diode configured to maintain a current path between the connection port and the voltage converter after the switch assembly is turned off.

In some embodiments, the switch assembly includes two semiconductor switches with a common source and a common gate, or a bidirectional semiconductor switch.

In some embodiments, the semiconductor switch is a gallium nitride switch or a silicon carbide switch.

In some embodiments, a voltage difference between the first level and a reference level is between-50% and +20%, the reference level being equal to the output voltage of the voltage converter when the power supply device provides charging power to the to-be-charged device.

In some embodiments, the first time period is determined based on a delay time from the connection status becoming disconnection to a disconnection of an input terminal of the to-be-charged device, and the first time period is set between zero and the delay time. The first time period is less than 20 ms, and the second time period is set between the first time period and 275 ms.

In some embodiments, the hot-plug protection method further includes, when the connection status between the power supply device and the to-be-charged device is detected as disconnected through the detection pin, after the second time period and within a third time period, reducing the output voltage of the voltage converter from the first level to a second level. The second level is equal to the output voltage of the voltage converter when the power supply device is in an unloaded state.

In some embodiments, the hot-plug protection method further includes, when the connection status between the power supply device and the to-be-charged device is detected as connected through the detection pin and a first predetermined condition is met, turning on the switch assembly to allow communication with the to-be-charged device. Whether the first predetermined condition is met is determined by detecting a voltage value of a power terminal of the connection port and the output voltage of the voltage converter. When the voltage value of the power supply terminal is less than or equal to a third predetermined voltage and the output voltage of the voltage converter is equal to the second level, it is determined that the first predetermined condition is met. The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

The accompanying drawings, which form part of the present disclosure, are provided to facilitate understanding of the present disclosure. The illustrative embodiments of the present disclosure and the description thereof serve to explain the disclosure and do not constitute improper limitations of the present disclosure.

In order to further illustrate the technical solutions in the embodiments of the present disclosure, the accompanying drawings that will be used in the description of the embodiments are briefly introduced below. It is apparent that the drawings described below represent only some embodiments of the present disclosure. Those skilled in the art will acquire other drawings based on these drawings, without exercising inventive labor.

FIG. 1 is a structural diagram of an application environment of a hot-plug protection method according to an embodiment;

FIG. 2 is a structural diagram of a power supply device according to an embodiment;

FIG. 3 is a schematic diagram illustrating a connection between a power supply device and a to-be-charged device according to an embodiment;

FIG. 4 is a schematic waveform diagram illustrating currents under different voltages according to an embodiment;

FIG. 5 is another schematic waveform diagram illustrating currents under different voltages according to another embodiment;

FIG. 6 is another schematic waveform diagram illustrating currents under different voltages according to another embodiment;

FIG. 7 is a schematic diagram of a power supply device according to an embodiment;

FIG. 8 is another schematic diagram of the power supply device according to another embodiment;

FIG. 9 is a schematic waveform diagram of voltages after a detection pin is shortened according to an embodiment;

FIG. 10 is a schematic flowchart of a hot-plug protection method according to an embodiment;

FIG. 11 is a schematic timing diagram of a hot-plug protection method according to an embodiment;

FIG. 12 is schematic waveform diagram of voltages after disconnection of the to-be-charged device and after a switch assembly is turned off according to an embodiment;

FIG. 13 is a schematic waveform diagram of a voltage Vadp at the moment of disconnection of the to-be-charged device according to an embodiment;

FIG. 14 is a schematic waveform diagram of a voltage V₀ maintained at a first level after disconnection of the to-be-charged device according to an embodiment; and

FIG. 15 is a schematic waveform diagram of a voltage V₀ decreasing to a second level after disconnection of the to-be-charged device according to an embodiment.

### DETAILED DESCRIPTION OF THE EMBODIMENTS

To facilitate a better understanding of the present disclosure, a more comprehensive description of the application will be provided with reference to the relevant accompanying drawings. The accompanying drawings illustrate a preferred embodiment of the present disclosure. However, it should be noted that the present disclosure can be implemented in various forms and is not limited to the embodiments described herein. Instead, these embodiments are intended to provide a thorough and comprehensive understanding of the content of the present disclosure.

Unless otherwise defined, all technical and scientific terms used in the present disclosure have the same meaning as commonly understood by those skilled in the art of the relevant technology field to which the present disclosure belongs. The terms used in the description of the present disclosure are solely for the purpose of describing specific embodiments and are not intended to limit the scope of the application. The term “and/or” used in the present disclosure includes any and all combinations of one or more of the related listed items.

When the terms “comprising”, “having” and “including” are used in the present disclosure, unless specifically limited by terms such as “only”, “consisting of”, etc., another component may be added. Unless indicated otherwise, singular terms should be interpreted as including the plural form and should not be understood as limited to a quantity of one.

It should be understood that, although the present disclosure may use terms such as “first”, “second”, etc., to describe various components, these terms should not be limiting. These terms are used solely to distinguish one component from another. For example, without departing from the scope of the present disclosure, the first component can be referred to as the second component, and similarly, the second component can be referred to as the first component.

In the present disclosure, unless otherwise expressly specified and limited, terms such as “connected” and “coupled” should be interpreted broadly. For example, it can refer to direct connection as well as indirect connection through an intermediate medium. It may also indicate an internal connection or interaction between two components. Those of ordinary skills in the art can understand the specific meanings of these terms in the context of the present disclosure based on the specific circumstances.

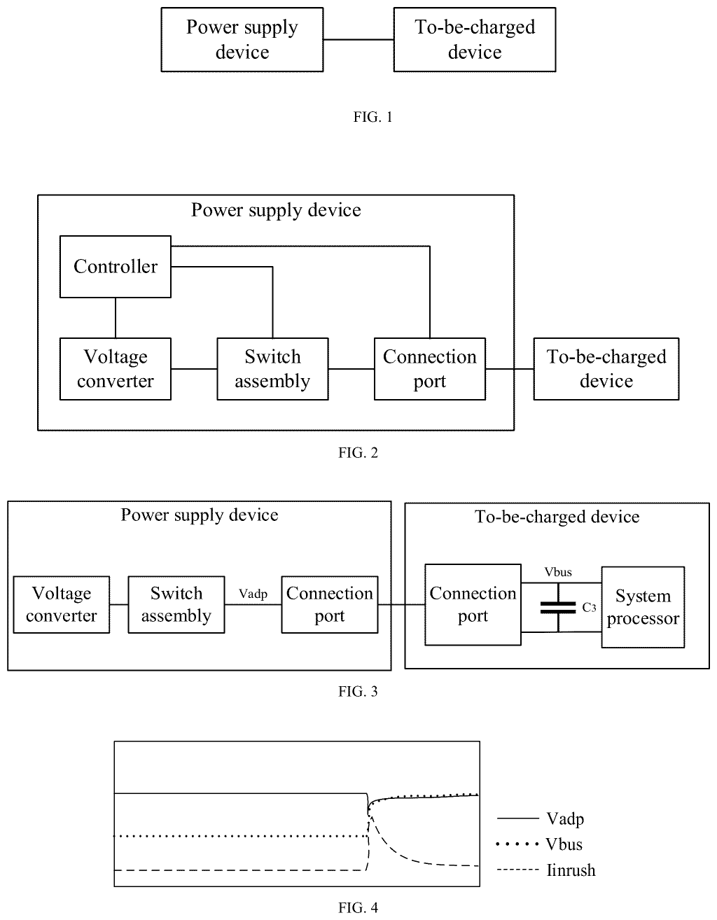

The hot-plug protection method provided in the present disclosure can be applied in an application environment as shown in FIG. 1, in which a power supply device is provide and includes at least one connection port. The power supply device can provide charging power to a to-be-charged device through the connection port. A connection port of the to-be-charged device matches the connection port of the power supply device. It should be understood that when the power supply device provides charging power to the to-be-charged device, a charging protocol between the parties should be followed. This charging protocol is a standardized protocol. Exemplarily, when the connection port is a Type-C interface, charging can be done according to the PD (USB Power Delivery) charging protocol. The PD charging protocol is one of the prevalent fast charging protocols, which is a power transmission protocol published by the USB-IF organization, and allows Type-C interfaces, which default to a maximum power of 5V/2A, to be increased to 240 W.

Further, the connection port of the power supply device includes a detection pin, which is configured to detect the connection status between the power supply device and the to-be-charged device. It should be understood that the connection port of the power supply device also includes a power pin configured to provide charging voltage to the to-be-charged device, and a communication pin configured to realize signal transmission between the power supply device and the to-be-charged device.

The to-be-charged device can include, but is not limited to, various personal computers, laptops, smartphones, tablets, Internet of Things (IoT) devices, and portable wearable devices. IoT devices can include smart speakers, smart TVs, smart air conditioners, smart car accessories, etc. Portable wearable devices can include smartwatches, fitness trackers, headsets, etc.

Referring to FIG. 2, in some embodiments, the present disclosure provides a power supply device, which specifically includes a controller, a voltage converter, a switch assembly, and a connection port.

The controller may include one or more processors, or a control assembly that includes one or more processors. The processor may include but are not limited to a CPU, a microcontroller unit (MCU), a microprocessor unit (MPU), a programmable logic controller (PLC), a digital signal processor (DSP), a system-on-chip (SoC), a field-programmable gate array processor (FPGA), an application-specific integrated circuit (ASIC), etc. The controller includes multiple output terminals connected to a control terminal of the voltage converter, a control terminal of the switch assembly, and a communication pin of the connection port, respectively, and configured to provide hot-plug protection for the power supply device based on predetermined conditions. Specifically, the controller outputs different control signals to the voltage converter and the switch assembly such that the voltage converter outputs corresponding voltages based on the control signals and settings, and the switch assembly is turned on or off according to the control signals. The controller is also configured to establish signal transmission with the to-be-charged device through the communication pin when the to-be-charged device is connected to the connection port.

Referring to FIG. 3, the voltage converter, the switch assembly, and the connection port are connected in sequence. When the connection port of the power supply device is connected to the connection port of the to-be-charged device, the power supply device can provide charging power to the to-be-charged device through the connection ports. At this time, the voltage on the power supply device side is referred to as Vadp, and the voltage on the to-be-charged device side is referred to as Vbus.

When Vadp>Vbus, the current flowing from the power supply device to the to-be-charged device may lead to sparking. Specifically, when the capacitor C3 is under a small heavy load and after the connection port of the to-be-charged device is unplugged, the discharge process is slower at the power supply device end than at the to-be-charged device end. When the connection port of the to-be-charged device is then plugged, there is a high probability of sparking occurring from the power supply device end to the to-be-charged device end.

When Vadp<Vbus, the current flowing from the to-be-charged device to the power supply device may result in sparking. Specifically, when the capacitor C3 is under a large light load and after the connection port of the to-be-charged device is unplugged, the discharge process is faster at the power supply device end than at the to-be-charged device end. When the connection port is then plugged, there is a low probability of sparking occurring from the to-be-charged device end to the power supply device end.

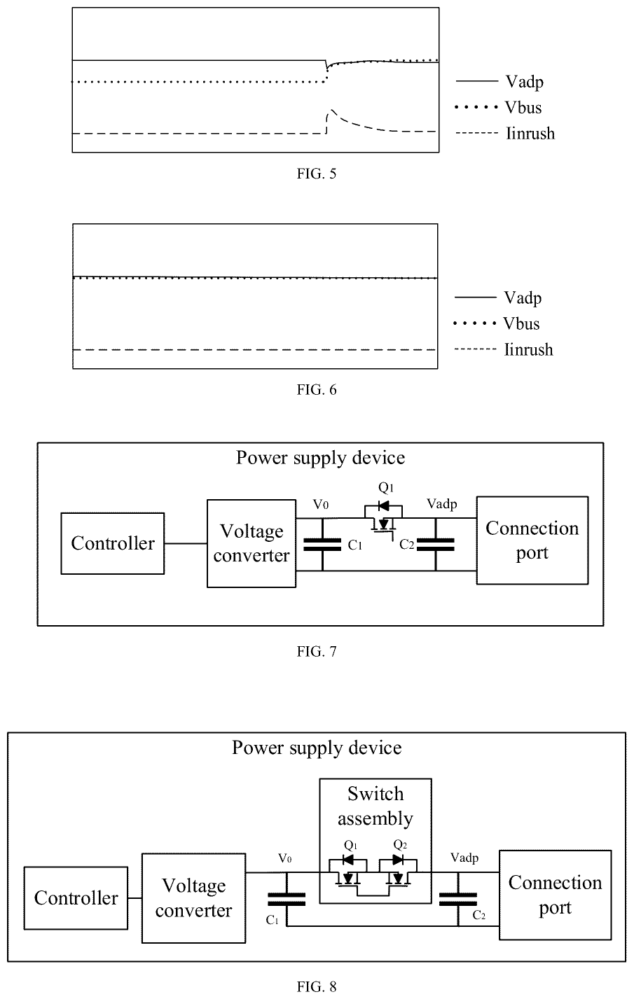

Referring to FIGS. 4-6, which shows the values of the current linrush between the power supply device end and the to-be-charged device end under different voltage differences between Vadp and I′bus. In these cases, the capacitance value of the capacitor C3 is 10 uF. FIG. 4 shows a simulation of the case where the voltage Vadp slowly discharges to 20V and the voltage I′bus quickly discharges to 9V after the to-be-charged device end is unplugged. The current linrush is 28.3 A when the connection between the two ends is established, which can reproduce sparking. FIG. 5 shows a simulation of the case where the voltage Vadp slowly discharges to 20V and the voltage I′bus quickly discharges to 15V after the to-be-charged device end is unplugged. The current linrush is 13.3 A when the connection between the two ends is established, which is significantly lower than that in FIG. 4, and there is no obvious sparking in this case. FIG. 6 shows a simulation of the case where the voltage Vadp slowly discharges to 20V and the voltage I′bus quickly discharges to 20V after the to-be-charged device end is unplugged. The current linrush is approximately zero when the connection between the two ends is established, indicating there is no obvious sparking. It can be seen that the lower the voltage difference between the power supply device end and the to-be-charged device end, the smaller the value of the current linrush, and the lower the probability of sparking. Based on this, the present disclosure reduces the probability of sparking when the to-be-charged device is connected to the power supply device by controlling the voltage difference between the two ends.

Specifically, the controller can detect the connection status between the power supply device and the to-be-charged device through, for example, a detection pin. When the connection status between the power supply device and the to-be-charged device is detected as connected, the controller outputs a control signal to the control terminal of the switch assembly to turn on the switch assembly. At this time, the output voltage of the voltage converter is transmitted to an input terminal of the to-be-charged device through the switch assembly and the connection port, providing power to the to-be-charged device. When detecting the connection status between the power supply device and the to-be-charged device as disconnected, the controller outputs, within a first time period, a control signal to the control terminal of the switch assembly to turn off the switch assembly. Further, within a second time period, the controller maintains the output voltage of the voltage converter at a first level to prevent the voltage difference between the to-be-charged device and the power supply device from exceeding a preset value, for example, 5V when the to-be-charged device is connected to the connection port of the power supply device which may otherwise cause sparking between the to-be-charged device end and the power supply device end. The first time period is shorter than the second time period.

Referring to FIG. 7, exemplarily, the switch assembly in this embodiment includes a MOSFET, i.e., the switch transistor Q1 shown in FIG. 7. The MOSFET comprises a body diode, where the cathode of the body diode is connected to the positive terminal of the output of the voltage converter, and the anode of the body diode is connected to the power pin of the connection port of the power supply device. This configuration ensures the current path between the connection port and the voltage converter is maintained after the MOSFET is turned off. It should be understood that the mentioned transistor structure is only one example, and other controllable switch transistors and diodes can be used to achieve the same functionality in practical applications.

Referring to FIG. 8, in some embodiments, the switch assembly also includes two semiconductor switches connected in series with a common source and a common gate, or a bidirectional semiconductor switch. These semiconductor switches may be gallium nitride (GaN) switches or silicon carbide (SiC) switches. When using two semiconductor switches, the reversely connected semiconductor switches can prevent energy backflow.

Continuing to refer to FIG. 7, a capacitor C1 is further provided between the output of the voltage converter and the ground line of the power supply device to filter the output voltage V₀ of the voltage converter. A capacitor C2 is arranged between the power pin of the connection port and the ground line of the power supply device. When the to-be-charged device is connected to the power supply device, the switch assembly is turned on, and the voltage Vadp across the capacitor C2 is equal to the output voltage V₀ of the voltage converter, providing a charging voltage for the connected to-be-charged device. When detecting that the to-be-charged device is disconnected, the controller sends, within the first time period, a control signal to the control terminal of the switch transistor Q1 to turn off the switch transistor Q1. At this time, the voltage Vadp discharges through the capacitor C2. By properly setting the capacitance of the capacitor C2, such as 0.1 uF, the voltage Vadp can drop rapidly. In addition, the controller maintains, within the second time period, the output voltage V₀ of the voltage converter at the first level, and the diode is in a reverse-biased state, thereby avoiding or significantly mitigating the occurrence of sparking between the to-be-charged device end and the power supply device end.

In some embodiments, to reduce the occurrence of sparking during a hot-plug operation, the connection port of the power supply device is also improved in the present embodiment. Specifically, the connection port includes multiple pins, including a detection pin, a power pin, and a communication pin. The length of the detection pin is shorter than those of the remaining pins, with a difference ranging from 0.3 to 0.5 mm. By this design, when the power supply device and the to-be-charged device are disconnected, the controller can detect the disconnection more quickly, enabling faster shutdown of the switch assembly.

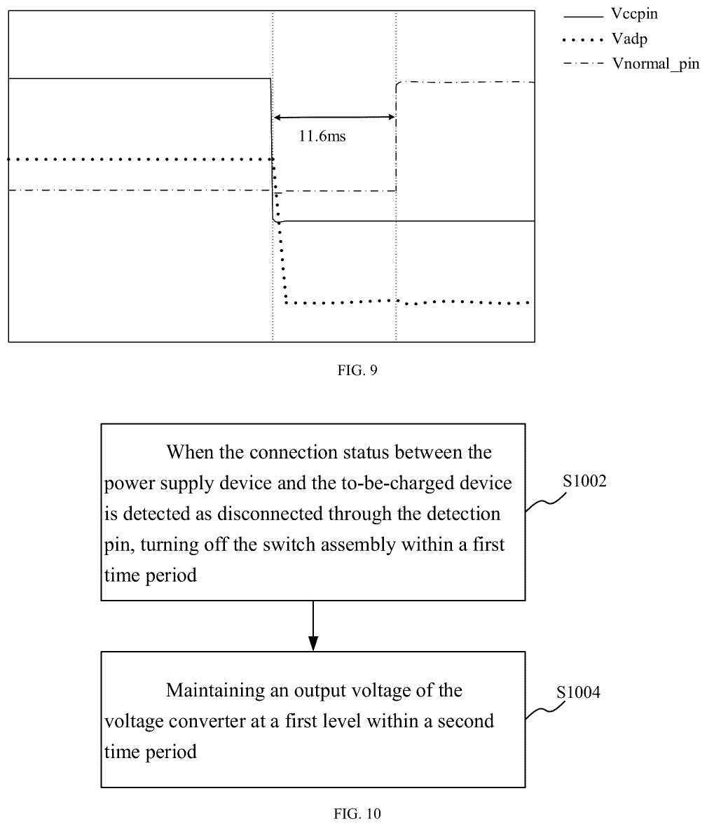

FIG. 9 shows a schematic diagram of the voltage waveform on a shortened detection pin. In the diagram, Vnormal_pin represents the voltage value on a normal-length pin of the connection port of the power supply device, Vccpin represents the voltage value on the shortened detection pin, and Vadp represents the voltage across the capacitor C2. From the waveforms in FIG. 9, it can be seen that when the detection pin is disconnected, the time difference between the voltage changes of Vccpin and Vnormal_pin is 11.6 ms, and during this time, the voltage Vadp has discharged to 0V. It can be seen that by appropriately shortening the length of the detection pin, the controller can detect the disconnection status more quickly, enabling faster shutdown of the switch assembly.

The above-described power supply device detects the connection status between the power supply device and the to-be-charged device through the detection pin. When a disconnection is detected, the switch assembly is immediately disconnected in order to prevent sparking between the power supply device and the to-be-charged device. Additionally, within a short period of time, the output voltage of the voltage converter is maintained at a first level to prevent sparking from the to-be-charged device to the power supply end due to an overlarge voltage difference when the to-be-charged device is connected to the connection port. With this solution, the surge current on the connection port during the hot plug is suppressed to a safe level, effectively preventing or significantly reducing sparking, and improving the lifespan of the connection port.

Referring to FIG. 10, in some embodiments, the present disclosure provides a hot-plug protection method applied to a power supply device which includes a connection port for providing charging power to a to-be-charged device. Further, the connection port includes a detection pin configured to detect the connection status between the power supply device and the to-be-charged device. The method includes the following steps.

In step S1002, when a disconnection between the power supply device and the to-be-charged device is detected through the detection tin, the switch assembly is turned off with a first time period. The switch assembly is connected in series between the voltage converter and the connection port of the power supply device.

In step S1004, the output voltage of the voltage converter is maintained at the first level within the second time period. The first time period is shorter than the second time period.

Specifically, the charging protocol defines the timing for the power supply device and the to-be-charged device. Taking the PD (Power Delivery) charging protocol as an example, it specifies the timing of multiple action stages, and the specific timings for each stage are determined by the device manufacturer based on the hardware and system requirements. For instance, in this embodiment, tPDDebounce in the protocol is used to represent the delay time for the to-be-charged device to cut off the output voltage after detecting a disconnection of the detection pin, and an allowable range for the delay time is 10 to 20 ms. tSRCDisconnect in the protocol is used to represent the time for the power supply device to turn off the switch assembly after detecting a disconnection of the detection pin, and an allowable range for this time is 0 to 20 ms. Further, according to the PD charging protocol requirements, when the power supply device is not connected to the to-be-charged device, i.e., it is in an unloaded state, the output voltage of the voltage converter should be maintained at around 5V. It also requires that the time from the power supply device detecting a disconnection of the detection pin to adjusting the output voltage of the voltage converter to 5V is 275 ms.

Based on the timing specified in the PD charging protocol, in the embodiments of the present disclosure, when the power supply device detects a disconnection between itself and the to-be-charged device through the detection pin, it immediately turns off the switch assembly to avoid a significant voltage difference between the power supply device and the to-be-charged device which may lead to sparking at the connection. In some embodiments, the first time period is determined by the delay time between the connection status becoming disconnection and the input terminal of the to-be-charged device becoming disconnection, i.e., the tPDDebounce. In this embodiment, the first time period is set to be between zero and the delay time. For example, the first time period is less than 20 ms.

The second time period refers to the period for the controller to maintain the output voltage of the voltage converter at the first level. The setting of the second time period and the first voltage level is to maintain the reverse-biased state of the body diode of the switch assembly, thus avoiding energy feedback. For example, the second time period is set to be between the first time period and 275 ms. Additionally, the range of the voltage difference between the first voltage level and a reference level is between-50% and +20%. The reference level is the output voltage of the voltage converter when the power supply device provides charging power to the to-be-charged device.

In some embodiments, according to the embodiments of the present disclosure, the hot-plug protection method includes, when the detection pin detects a disconnection between the power supply device and the to-be-charged device, after the second time period and within a third time period, the output voltage of the voltage converter is lowered from the first level to a second level. The second level is the output voltage of the voltage converter when the power supply device is in an unloaded state. For example, the third time period is set to be between the second time period and 275 ms.

In the above embodiments, when the connection status between the power supply device and the to-be-charged device is detected as disconnected, the switch assembly is immediately turned off within the first time period to avoid sparking from the power supply device to the to-be-charged device. The output voltage of the voltage converter is maintained at the first level within the second time period, preventing sparking from the to-be-charged device to the power supply device due to an overlarge voltage difference. Finally, within the third time period, the output voltage is lowered from the first level to the second level, awaiting a connection signal with respect to the to-be-charged device. The timing meets the condition: 0≤first time periods second time period<third time period≤275 ms.

In some embodiments, the method for detecting the disconnection status between the power supply device and the to-be-charged device through the detection pin includes detecting the voltage value on the detection pin, and when the voltage value on the detection pin is greater than or equal to a first predetermined voltage, determining that the to-be-charged device and the power supply device are disconnected.

Specifically, the power supply device includes an input terminal and an output terminal. The input terminal is connected to an AC power source to convert AC power into DC power with a certain voltage that can be used by a connected to-be-charged device. When the input terminal of the power supply device is energized, the voltage on the detection pin varies depending on whether the output terminal is connected or disconnected to the load. By detecting the voltage changes, the connection status between the power supply device and the to-be-charged device can be determined. In this exemplary embodiment, the first predetermined voltage is set at 2.8V. If the voltage value on the detection pin is greater than or equal to 2.8V, it is determined that the to-be-charged device is disconnected from the power supply device.

In some embodiments, the hot-plug protection method of the embodiments also includes detecting the connection status between the power supply device and the to-be-charged device through a detection tin, and when the connection status is determined as connected and a first predetermined condition is met, turning on the switch assembly to allow communication with the to-be-charged device.

In some embodiments, the method of detecting the connection status between the power supply device and the to-be-charged device through the detection pin includes detecting the voltage value on the detection pin, and when the voltage value on the detection pin is less than or equal to a second predetermined voltage, determining that the to-be-charged device is connected to the power supply device. Exemplarily, the second predetermined voltage in this embodiment is 1.7V, and when the voltage value on the detection pin is less than or equal to 1.7V, it is determined that the to-be-charged device is connected to the power supply device.

In some embodiments, the determination of the first predetermined condition includes detecting the voltage value on the power pin of the connection port of the power supply device and the output voltage of the voltage converter, and when the voltage value on the power pin is less than or equal to a third predetermined voltage and the output voltage of the voltage converter is equal to the second level, determining that the first predetermined condition is met.

Specifically, at the moment when the to-be-charged device is connected to the connection port, the voltage value on the power pin of the connection port approaches zero, and the output voltage of the voltage converter remains at the second level. At this time, the power supply device is in normal working condition, capable of communicating with the connected to-be-charged device and providing charging power. Exemplarily, the third predetermined voltage in this embodiment is 0.8V, and the second level is 5V. It should be understood that the values of the first predetermined voltage, second predetermined voltage, and third predetermined voltage can be appropriately adjusted as needed. For example, the range of the second level can be set between 4.5V to 5.5V, meaning that when the detected output voltage of the voltage converter is greater than or equal to 4.5V and less than or equal to 5.5V, it is considered to meet the requirement.

Further, after powering on, the controller of the power supply device will constantly monitor the voltage value on the detection pin to determine the connection status between the power supply device and the to-be-charged device. If the connection status is determined as disconnected, the method steps described in the above embodiments will be immediately performed to avoid any sparking caused by an overlarge voltage difference between the power supply device and the to-be-charged device. If the connection status is determined as connected, the controller will continue to monitor the voltage values on the power pin of the connection port and the output terminal of the voltage converter. When the voltage values meet the first predetermined condition, the switch assembly will be turned on to allow communication with the connected to-be-charged device and provide the connected to-be-charged device with an appropriate charging voltage.

In order to help those skilled in the art fully understand the disclosure, detailed explanations of the mechanism of the hot-plug protection method described in the present disclosure are provided below.

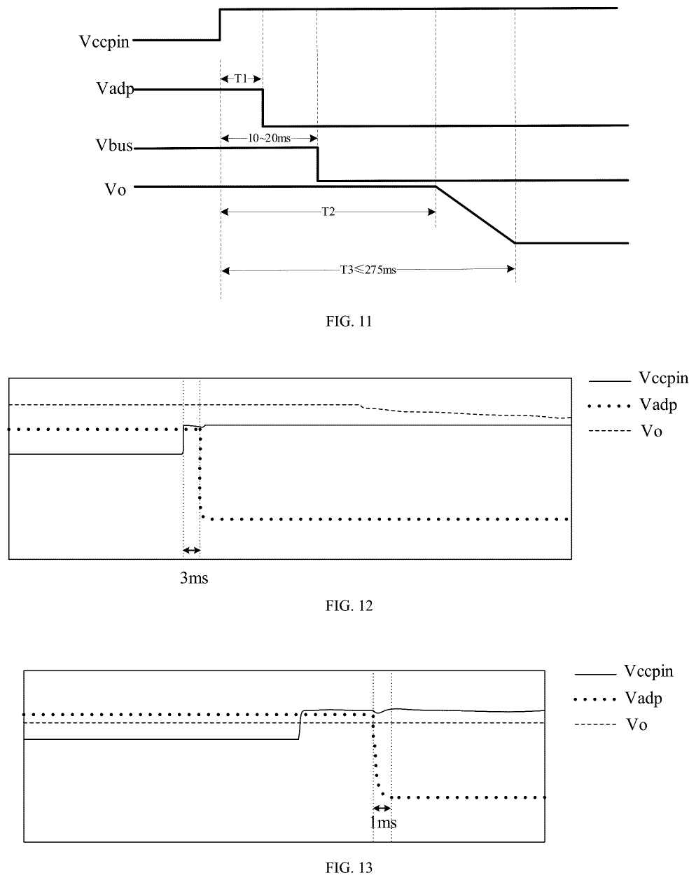

Please refer to FIG. 7 and FIG. 11. FIG. 11 shows a timing diagram for the hot-plug protection method in the present embodiment, where Vccpin represents the voltage value on the detection pin, Vadp represents the voltage value across the capacitor C2, Vbus represents the voltage value at the connection of the to-be-charged device, and V₀ represents the output voltage of the voltage converter.

When the power supply device is charging the to-be-charged device, the voltage value Vccpin is less than or equal to the second predetermined voltage, while the voltages Vadp, Vbus, and V₀ are all at a high level. The specific voltage values depend on the model of the to-be-charged device.

When the controller detects a voltage jump on the detection pin, and the voltage after the jump is greater than or equal to the first predetermined voltage, it is considered that the power supply device and the to-be-charged device have been disconnected. The voltage Vbus starts to decrease from the moment of the voltage jump. If the switch transistor Q1 is turned off within the first time period (represented as T1 in the diagram), the voltage Vadp starts to decrease after the switch transistor Q1 is turned off. To prevent energy from flowing back from the to-be-charged device to the power supply device due to Vbus being greater than Vadp, the voltage V₀ is maintained at the first level within the second period (represented as T2 in the diagram), keeping the body diode of the switch transistor Q1 in a reverse-biased state. After the voltage I′bus is completely discharged, within the third time period (represented as T3 in the diagram), the voltage V₀ is lowered to the second level, waiting for the connection signal with respect to the to-be-charged device.

Referring to FIG. 12, which shows the voltage waveforms after disconnection of the to-be-charged device and after the switch assembly is turned off, it can be seen that when the detection pin is disconnected, the voltage Vccpin thereon immediately changes and rises to a high level. During the first time period from the disconnection of the detection pin, the voltages Vadp and V₀ are at the same potential. Exemplarily, the required charging voltage for the to-be-charged device is 20V at this time. When the switch transistor Q1 is turned off within the first time period from the disconnection of the detection pin, the voltage Vadp starts to decrease from 20V to 0V. In this case, the first time period is approximately 3 ms, which meets the requirements of the PD charging protocol. It should be noted that FIG. 12 is an amplified view of the voltage waveforms, and with a charging voltage of 20V, the voltage difference between Vadp and V₀ is approximately 0.1V, which can be considered as equipotential.

Referring to FIG. 13 which shows the voltage waveform of the voltage Vadp at the moment of the disconnection, it can be seen that when the detection pin is disconnected, it takes approximately 1 ms for the voltage Vadp to decrease from 20V to 0V. Additionally, the capacitance value of C2 is relatively small, only 0.0 uF, which prevents any sparking from the power supply device to the to-be-charged device.

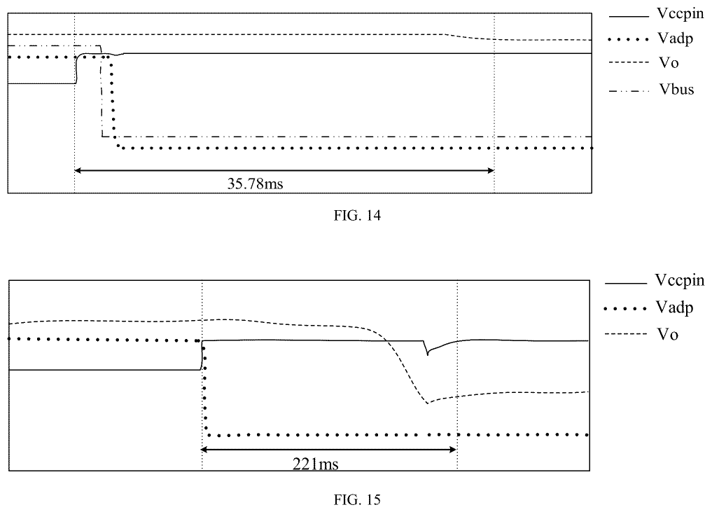

Referring to FIG. 14 which shows the waveform diagram of the voltage V₀ maintained at the first level after disconnection, it can be seen that when the detection pin is disconnected, the voltage Vccpin immediately changes and rises to a high level. The voltages Vadp and Vbus start to decrease, and within the second time period, the voltage V₀ is maintained within a certain range of error around 20V. This ensures that the potential at the cathode of the diode is greater than that at the anode of the diode, keeping the diode in the reverse-biased state and preventing sparking from the to-be-charged device to the power supply device. At this point, the second time period is approximately 35 ms, meeting the requirements of the PD charging protocol.

Referring to FIG. 15, which shows the waveform diagram of the voltage V₀ decreasing from the first level to the second level after disconnection, it can be seen that when the detection pin is disconnected, the voltage V₀ is maintained at 20V within the second time period. Within the third time period, the voltage V₀ decreases from 20V to 5V. In this case, the third time period is 221 ms, meeting the condition tPDDebounce<second time period<third time period<275 ms, which meets the requirements of the PD charging protocol.

The above hot-plug protection method involves detecting the connection status between the power supply device and the to-be-charged device through the detection pin. When a disconnection is detected, the switch assembly is immediately turned off within the first time period to prevent sparking from the power supply device to the to-be-charged device. Further, within the second time period, the output voltage of the voltage converter is maintained at the first level to prevent sparking from the to-be-charged device to the power supply due to the overlarge voltage difference therebetween when the to-be-charged device is connected to the connection port. With the above solution, the surge current at the connection port during the hot-plug operation can be suppressed to a safe value, avoiding or mitigating sparking and improving the lifespan of the connection port.

It is to be noted that the above embodiments are for illustrative purposes only and are not intended to limit the disclosure.

The various embodiments described in this disclosure are presented in a progressive manner, with each embodiment highlighting the differences from the others. The common or similar parts among the embodiments can be cross-referenced to each other.

The various technical features of the above-described embodiments can be combined in any manner. To keep the description concise, not all possible combinations of the technical features in the above embodiments have been described. However, as long as the combination of these technical features is not contradictory, it should be considered within the scope of the present specification.

The above-described embodiments only represent several possible implementations of the present disclosure, and their descriptions are specific and detailed. However, this should not be interpreted as limiting the scope of the patent application. It should be noted that those skilled in the art can make various modifications and improvements without departing from the conceptual essence of the present disclosure, and all such modifications and improvements are within the scope of protection of the present disclosure. Therefore, the scope of protection of the patent application should be determined by the claims attached hereto.

What is claimed is:

1. A hot-plug protection method for a power supply device, wherein the power supply device comprises:
a connection port, through which the power supply device provides charging power to a to-be-charged device, the connection port comprising a detection pin that detects the connection status between the power supply device and the to-be-charged device;
a voltage converter; and
a switch assembly connected in series between the voltage converter and the connection port, and
wherein the method comprises:
when the connection status between the power supply device and the to-be-charged device is detected as disconnected through the detection pin, turning off the switch assembly within a first time period; and
maintaining an output voltage of the voltage converter at a first level within a second time period, the first time period being shorter than the second time period.

2. The method according to claim 1, wherein the first time period is determined based on a delay time from the connection status becoming disconnection to a disconnection of an input terminal of the to-be-charged device, and the first time period is set between zero and the delay time.

3. The method according to claim 2, wherein the first time period is less than 20 ms, and the second time period is set between the first time period and 275 ms.

4. The method according to claim 1, wherein a voltage difference between the first level and a reference level is between-50% and +20%, the reference level being equal to the output voltage of the voltage converter when the power supply device provides charging power to the to-be-charged device.

5. The method according to claim 1, further comprising:
when the connection status between the power supply device and the to-be-charged device is detected as disconnected through the detection pin, after the second time period and within a third time period, reducing the output voltage of the voltage converter from the first level to a second level, the second level being equal to the output voltage of the voltage converter when the power supply device is in an unloaded state.

6. The method according to claim 5, wherein the third time period is set between the second time period and 275 ms.

7. The method according to claim 1, wherein the connection status between the power supply device and the to-be-charged device being detected as disconnected through the detection pin comprises:
detecting a voltage value on the detection pin, and when the voltage value on the detection pin is greater than or equal to a first predetermined voltage, determining that the to-be-charged device and the power supply device are disconnected.

8. The method according to claim 1, further comprising:
when the connection status between the power supply device and the to-be-charged device is detected as connected through the detection pin and a first predetermined condition is met, turning on the switch assembly to allow communication with the to-be-charged device.

9. The method according to claim 1, wherein within the second time period, the voltage difference between the power supply device and the to-be-charged device is less than or equal to 5V.

10. The method according to claim 8, wherein the connection status between the power supply device and the to-be-charged device being detected as connected through the detection pin comprises:
detecting a voltage value on the detection pin, and when the voltage value on the detection pin is less than or equal to a second predetermined voltage, determining that the to-be-charged device is connected to the power supply device.

11. The method according to claim 8, wherein whether the first predetermined condition is met is determined by detecting a voltage value of a power terminal of the connection port and the output voltage of the voltage converter, and when the voltage value of the power supply terminal is less than or equal to a third predetermined voltage and the output voltage of the voltage converter is equal to the second level, it is determined that the first predetermined condition is met.

12. The method according to claim 8, wherein the connection port comprises multiple pins comprising the detection pin, and a length of the detection pin is shorter than those of remaining pins, with a difference ranging from 0.3 to 0.5 mm.

13. A power supply device, comprising:
a connection port comprising a detection pin;
a controller;
a voltage converter, configured to output corresponding voltages according to instructions from the controller; and
a switch assembly, connected in series between the voltage converter and the connection port, and configured to turn on or turn off a power output of the power supply device according to control signals from the controller,
wherein the controller is configured to perform a hot-plug protection method comprising:
when a connection status between the power supply device and a to-be-charged device is detected as disconnected through the detection pin, turning off the switch assembly within a first time period; and
maintaining an output voltage of the voltage converter at a first level within a second time period, the first time period being shorter than the second time period.

14. The power supply device according to claim 13, wherein the switch assembly comprises a MOSFET with a body diode configured to maintain a current path between the connection port and the voltage converter after the switch assembly is turned off.

15. The power supply device according to claim 13, wherein the switch assembly comprises two semiconductor switches with a common source and a common gate, or a bidirectional semiconductor switch.

16. The power supply device according to claim 15, wherein the semiconductor switch is a gallium nitride switch or a silicon carbide switch.

17. The power supply device according to claim 13, wherein a voltage difference between the first level and a reference level is between-50% and +20%, the reference level being equal to the output voltage of the voltage converter when the power supply device provides charging power to the to-be-charged device.

18. The power supply device according to claim 13, wherein the first time period is determined based on a delay time from the connection status becoming disconnection to a disconnection of an input terminal of the to-be-charged device, and the first time period is set between zero and the delay time, and
wherein the first time period is less than 20 ms, and the second time period is set between the first time period and 275 ms.

19. The power supply device according to claim 13, wherein the hot-plug protection method further includes:
when the connection status between the power supply device and the to-be-charged device is detected as disconnected through the detection pin, after the second time period and within a third time period, reducing the output voltage of the voltage converter from the first level to a second level, the second level being equal to the output voltage of the voltage converter when the power supply device is in an unloaded state.

20. The power supply device according to claim 13, wherein the hot-plug protection method further includes:
when the connection status between the power supply device and the to-be-charged device is detected as connected through the detection pin and a first predetermined condition is met, turning on the switch assembly to allow communication with the to-be-charged device,
wherein whether the first predetermined condition is met is determined by detecting a voltage value of a power terminal of the connection port and the output voltage of the voltage converter, and when the voltage value of the power supply terminal is less than or equal to a third predetermined voltage and the output voltage of the voltage converter is equal to the second level, it is determined that the first predetermined condition is met.
